(19) United States
(12) Patent Application Publication
(10) Pub. No.: US 2014/0209434 A1
(43) Pub. Date: Jul. 31, 2014

(54) APPARATUS FOR USE WITH FIXTURE ASSEMBLY AND WORKPIECE

(71) Applicant: HONDA MOTOR CO., LTD, Tokyo (JP)

(72) Inventor: Roy Potts, Stayner (CA)

(73) Assignee: HONDA MOTOR CO., LTD., Tokyo (JP)

(21) Appl. No.: 13/756,192

(22) Filed: Jan. 31, 2013

(51) Int. Cl. B65G 43/08

(52) U.S. Cl. CPC B65G 43/08
USPC 198/502.3

(57) ABSTRACT

An apparatus for use with a fixture assembly and a workpiece. The apparatus includes a frame assembly and a detector assembly. The detector assembly is configured to couple to the frame assembly. The detector assembly is also configured to detect an occurrence in which the fixture assembly remains inadvertently non-separated from the workpiece while the workpiece is moved.

### TECHNICAL FIELD

Aspects generally relate to (and are not limited to) an apparatus for use with a fixture assembly and a workpiece.

### BACKGROUND

A workpiece is either raw material or a partially finished piece that is shaped by performing various operations.

A fixture assembly is a work-holding or support device used in the manufacturing industry. What makes a fixture unique is that each one is built to fit a particular part or shape. The main purpose of a fixture is to locate, and in some cases, hold the workpiece during either a machining operation or some other industrial process.

### SUMMARY

I, the inventor, have researched a problem associated with known fixture assemblies and workpieces. After much study, I believe I have arrived at an understanding of the problem and its solution(s), which are stated below.

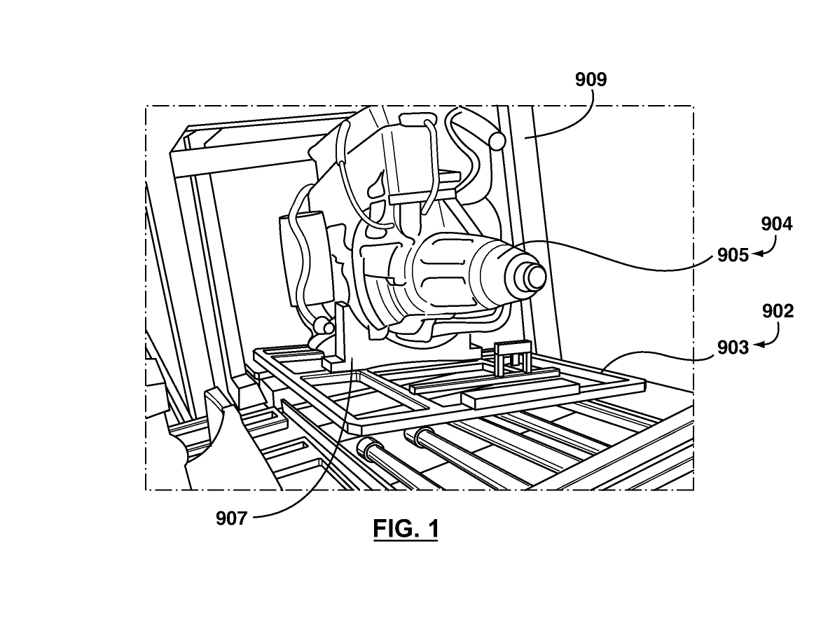

FIG. 1 depicts a perspective view of a fixture assembly 902 and of a workpiece 904. For example, the fixture assembly 902 includes a pallet assembly 903, and the workpiece 904 includes an engine assembly 905. The pallet assembly 903 supports or provides a cradle assembly 907 configured to cradle the engine assembly 905. There is an interference fit between the cradle assembly 907 and the engine assembly 905. When the workpiece 904 is moved, the fixture assembly 902 may remain inadvertently connected or coupled to the workpiece 904, and thus the fixture assembly 902 is inadvertently moved along with the workpiece 904. More specifically, during the unloading of the engine assembly 905 from a shipping rack system 909 for delivery to a work station or work cell, the engine assembly 905 sits in the cradle assembly 907 on the pallet assembly 903. The cradle assembly 907 sometimes remains attached to the bottom of the engine assembly 905 when the engine assembly 905 is hoisted out. In particular, the engine assembly 905 is typically raised by a hoist assembly to a first elevated position for subsequent scanning by a bar code scanner. After scanning, the assembly-line worker presses an advance button of a hoist system in order to move the engine assembly 905 to the work station. At this point, the hoist assembly lifts the engine assembly 905 to a second elevated position for delivery to the work station. If the assembly-line worker does not notice that the pallet assembly 903 remains attached to the engine assembly 905 and presses the advance button, the engine assembly 905 and pallet assembly 903 are inadvertently raised (together) to the second elevated position. At any point during delivery to the work station, the pallet assembly 903 may become separated from the engine assembly 905 and fall (freely), and the pallet assembly 903 may inadvertently strike equipment or personnel leading to potential damage and/or injury. The above condition creates safety issues and reduces workplace efficiencies.

In accordance with an aspect of my work, I (the inventor) have developed an apparatus for use with a fixture assembly and a workpiece. The apparatus includes a frame assembly and a detector assembly. The detector assembly is configured to couple to the frame assembly. The detector assembly is also configured to detect an occurrence in which the fixture assembly remains inadvertently non-separated from the workpiece while the workpiece is moved.

In accordance with another aspect of my work, I (the inventor) have developed a method for use with a fixture assembly and a workpiece. The method includes detecting an occurrence in which the fixture assembly remains inadvertently non-separated from the workpiece while the workpiece is moved.

In accordance with other aspects of my work, I (the inventor) have developed and provided other aspects as provided in the claims.

Other aspects and features of the non-limiting embodiments may now become apparent to those skilled in the art upon review of the following detailed description of the non-limiting embodiments with the accompanying drawings.

### DETAILED DESCRIPTION OF DRAWINGS

The non-limiting embodiments may be more fully appreciated by reference to the following detailed description of the non-limiting embodiments when taken in conjunction with the accompanying drawings, in which:

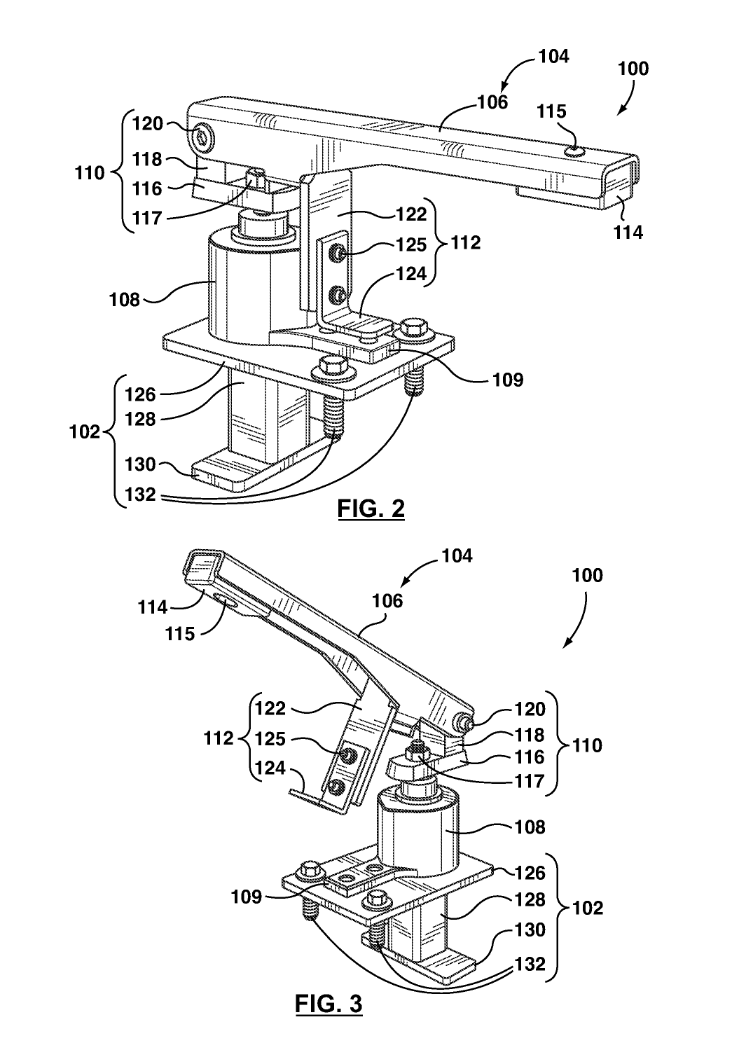

FIG. 2 depicts a perspective view of an example of an apparatus having a detector assembly;

FIG. 3 depicts another perspective view of an example of the detector assembly of FIG. 1;

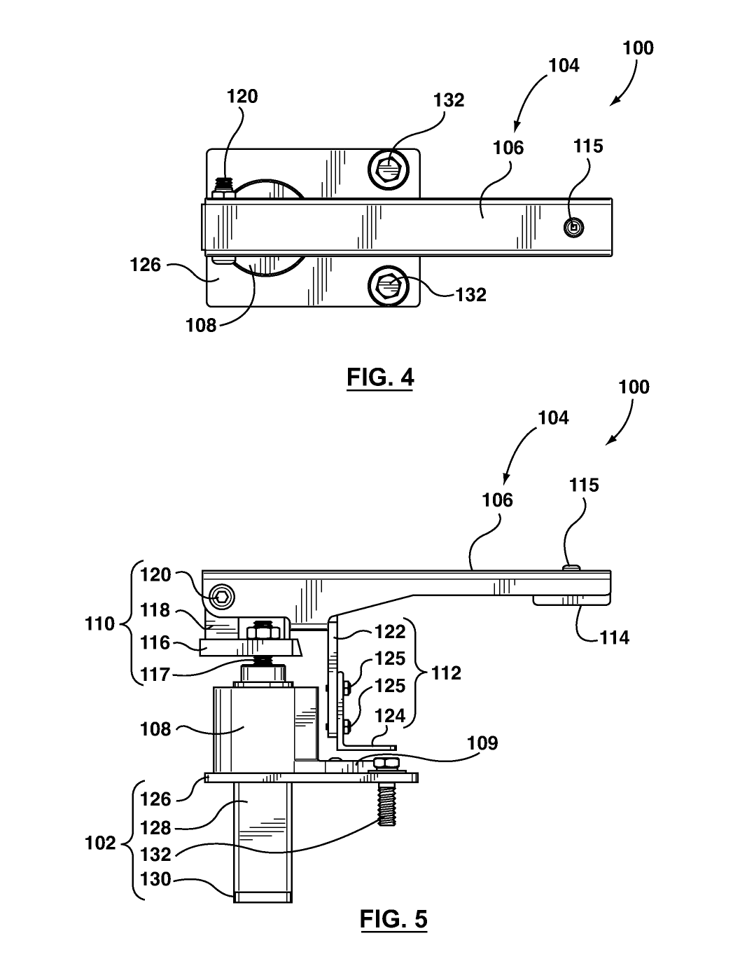

FIG. 4 depicts a top view of an example of the detector assembly of FIG. 1;

FIG. 5 depicts a side view of an example of the detector assembly of FIG. 1;

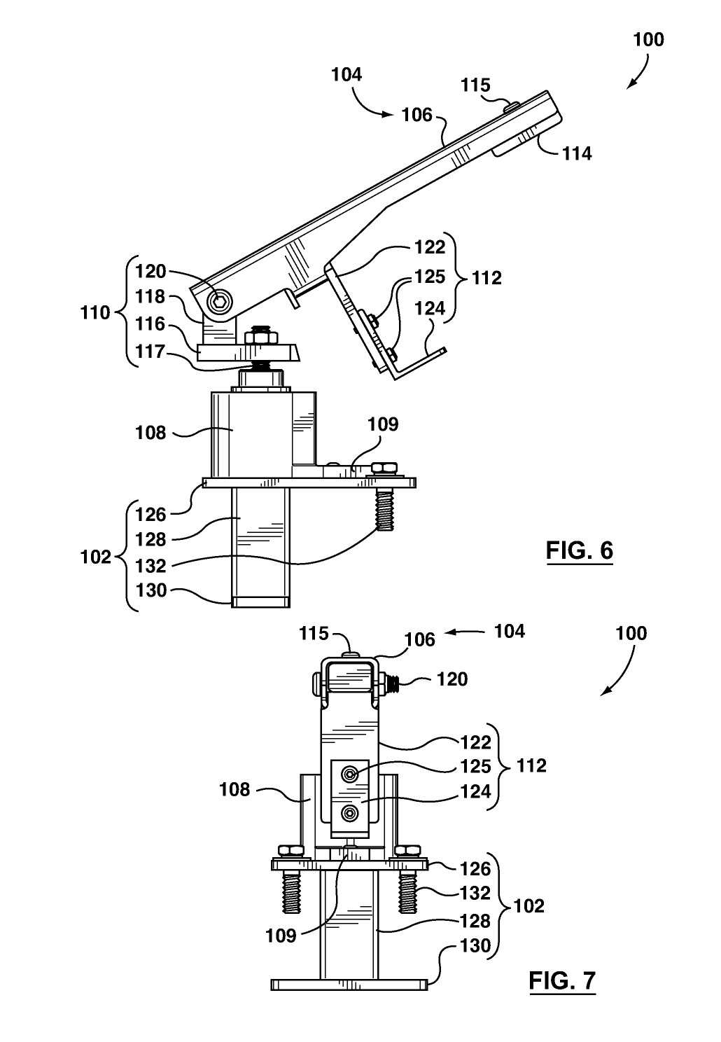

FIG. 6 depicts a side view of an example of the detector assembly of FIG. 1;

FIG. 7 depicts a frontal view of an example of the detector assembly of FIG. 1;

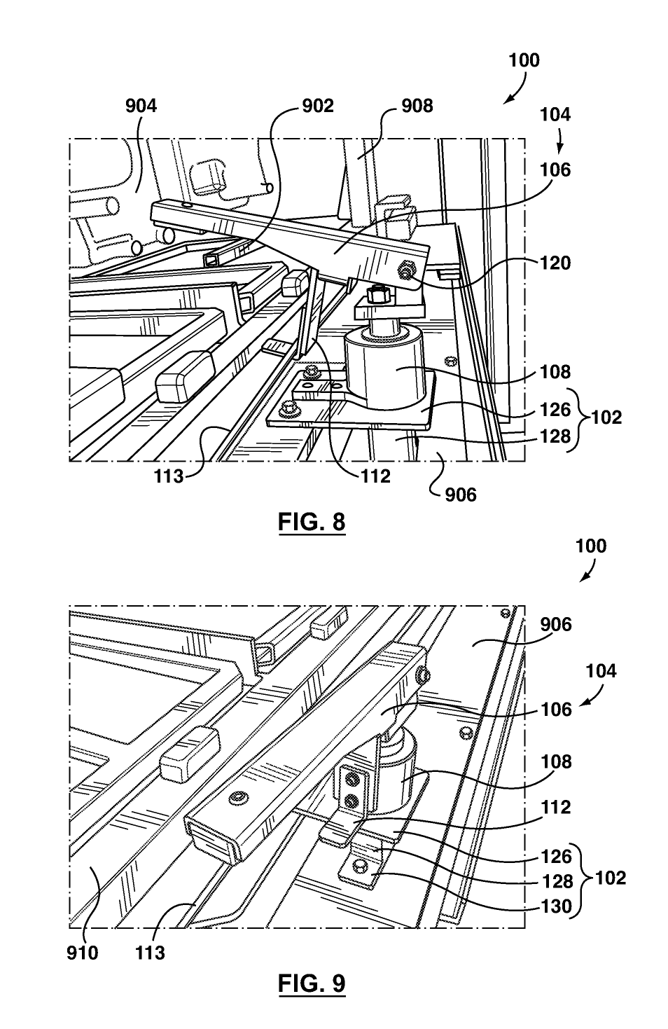

FIG. 8 depicts a perspective view of an example of the detector assembly of FIG. 1; and

FIG. 9 depicts another perspective view of an example of the detector assembly of FIG. 1.

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE EXEMPLARY EMBODIMENTS

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the examples as oriented in the drawings. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments (examples), aspects and/or concepts defined in the appended claims. Hence, specific dimensions and other physical characteristics relating to the embodiments disclosed herein are not to be considered as limiting, unless the claims expressly state otherwise.

Referring to FIG. 2, there is depicted the perspective view of the example of an apparatus 100. Generally speaking, the apparatus 100 is for use with the fixture assembly 902 and the workpiece 904, both depicted in FIGS. 1 and 8. The apparatus 100 includes a frame assembly 102 and a detector assembly 104. The detector assembly 104 is configured to couple to the frame assembly 102. As well, the detector assembly 104 is further configured to detect an occurrence in which the fixture assembly 902 remains inadvertently non-separated from the workpiece 904 while the workpiece 904 is moved (such as hoisted, etc.). The apparatus 100 improves, at least in part, workplace safety and/or workplace efficiency.

The definition of “non-separated” is that the fixture assembly 902 cannot voluntarily (easily) separate (release) from the workpiece 904 as the workpiece 904 is moved away from the fixture assembly 902. An example may include a case where the fixture assembly 902 cannot voluntarily separate from the workpiece 904 because the fixture assembly 902 experiences an (inadvertent or unwanted) interference fit (press fit, friction fit) with the workpiece 904 that causes inadvertent continued connection between the fixture assembly 902 and the workpiece 904 as the workpiece 904 is moved away from the fixture assembly 902. Another example may include the case where the fixture assembly 902 remains inadvertently fixedly coupled (directly or indirectly) to the workpiece 904 that causes unwanted continued connection between the fixture assembly 902 and the workpiece 904 as the workpiece 904 is moved away from the fixture assembly 902.

In accordance with FIGS. 2, 3, 4, 5, 6, 7, 8, the detector assembly 104 is depicted in the inboard position. In accordance with FIG. 9, the detector assembly 104 is depicted in the outboard position. The detector assembly 104 is configured to selectively operate in any one of the inboard position and the outboard position. In the inboard position, the detector assembly 104 is enabled to detect the occurrence in which the fixture assembly 902 remains inadvertently non-separated from the workpiece 904 while the workpiece 904 is moved. In the outboard position, the detector assembly 104 is disabled from detecting any occurrence in which the fixture assembly 902 remains inadvertently non-separated from the workpiece 904 while the workpiece 904 is moved. For example, FIG. 9 depicts the case where the detector assembly 104 is in a broken (non-operable) state, the detector assembly 104 may be placed in the outboard position and awaits repair by a qualified repair technician.

In accordance with FIGS. 2, 4, 5, 7, the detector assembly 104 is depicted in the un-tripped condition. In accordance with FIGS. 3, 6, 8, the detector assembly 104 is depicted in the tripped condition. The detector assembly 104 is configured to selectively operate in any one of the un-tripped condition and the tripped condition. In the un-tripped condition, the detector assembly 104 is ready to detect the occurrence in which the fixture assembly 902 remains inadvertently non-separated from the workpiece 904 while the workpiece 904 is moved. In the tripped condition, the detector assembly 104 has detected the occurrence in which the fixture assembly 902 remains inadvertently non-separated from the workpiece 904 while the workpiece 904 is moved.

Referring back to the example depicted in FIG. 2, the detector assembly 104 includes an arm assembly 106. The arm assembly 106 is configured to make selective physical contact with the fixture assembly 902 in response to the occurrence in which the fixture assembly 902 remains inadvertently non-separated from the workpiece 904 while the workpiece 904 is moved (this case or situation is depicted in FIG. 8). The arm assembly 106 may have an elongated, U-shaped metal body, and is configured to avoid becoming inadvertently bent or broken for the case where the arm assembly 106 makes repeated contact with (or strikes against) the fixture assembly 902, so as to improve durability of the detector assembly 104.

The detector assembly 104 may further include a pivotal assembly 108. Generally speaking, the pivotal assembly 108 is configured to operatively couple to the arm assembly 106. The pivotal assembly 108 is further configured to permit selective pivotal movement of the arm assembly 106 along any one of a vertically extending direction (or vertical plane) and a horizontally extending direction (or horizontal plane). FIGS. 2 and 3 depict the case where the pivotal assembly 108 permits pivotal movement of the arm assembly 106 along the vertically extending direction, between the un-tripped condition (shown in FIG. 2) and the tripped condition (shown in FIG. 3). The pivotal assembly 108 permits the arm assembly 106 to selectively vertically pivot along the vertical plane. FIGS. 8 and 9 depict the case where the pivotal assembly 108 permits pivotal movement of the arm assembly 106 along the horizontally extending direction, between the inboard position (as shown in FIG. 8) and the outboard position (as shown in FIG. 9. The pivotal assembly 108 permits the arm assembly 106 to selectively horizontally pivot along the horizontal plane.

An example of the pivotal assembly 108 includes a spring pivot module, Model or

Series number 7000, 7100, 7200, 7300 manufactured by BOMMER INDUSTRIES located in Landrum, South Carolina, U.S.A. (or any functional and/or structural equivalent).

Other components of the detector assembly 104 include a connection interface 109. The connection interface 109 is configured to connect the pivotal assembly 108 to the frame assembly 102 that is configured to be mount at a relatively stationary position (as depicted in FIGS. 8 and 9). A pivot interface 110 is configured to operatively connect the arm assembly 106 to the pivotal assembly 108. By way of example, the pivot interface 110 may include a platform assembly 116, a pivot fastener 117, an extension assembly 118, and a pivotal coupling (120). The platform assembly 116 may be a planar shaped metal body that is horizontally aligned, and is generally configured to support the arm assembly 106. The pivot fastener 117 is configured to operatively couple the platform assembly 116 to the pivotal assembly 108. The pivot fastener 117 may include: (i) a screw thread that extends from the pivotal assembly 108, and (ii) a nut. The nut is used to fasten the pivot fastener 117 to the screw thread so as to operatively connect the platform assembly 116 to the pivotal assembly 108. The extension assembly 118 is configured to fixedly connect with the platform assembly 116, and to extend (upwardly) from the platform assembly 116. The pivotal coupling (120) is configured to pivotally connect the arm assembly 106 to the extension assembly 118, so that the arm assembly 106 may pivotally move (in use) along the vertical plane from the un-tripped condition to the tripped condition in response to the fixture assembly 902 making contact with the arm assembly 106.

By way of example, the frame assembly 102 includes a support assembly 126, a base extension 128, a base assembly 130, and a coupler 132. The support assembly 126 is configured to support the pivotal assembly 108. The connection interface 109 of the pivotal assembly 108 is fixedly connected to the support assembly 126. The support assembly 126 may be a planar-shaped metal body, and may be horizontally aligned, and is generally configured to support the pivotal assembly 108. The base extension 128 is configured to extend (generally downwardly) from the support assembly 126. The base extension 128 may include a tubular-shaped member that is fixedly connected to the support assembly 126. The base assembly 130 is configured to fixedly connect to the base extension 128. The base assembly 130 may include a plate-shaped body that has a footprint extending on opposite sides of the base extension 128. The coupler 132 is configured to attach the support assembly 126 to a relatively stationary structure 906 as depicted in FIG. 9. Generally, the frame assembly 102 is configured to bear the weight of the detector assembly 104, and to maintain the pivotal assembly 108 in a relatively stationary position.

According to an option, the arm assembly 106 includes a wear assembly 114 mounted to an end portion or tip of the arm assembly 106. The wear assembly 114 may include a nylon body or other suitable material that is configured to resist wear in response to making repeated contact with the fixture assembly 902. The wear assembly 114 is configured to make selective contact with the fixture assembly 902. In addition, a connector assembly 115 is configured to fixedly connect the wear assembly 114 to the tip of the arm assembly 106.

The detector assembly 104 may further include a trip-wire interface assembly 112. Generally speaking, the trip-wire interface assembly 112 is configured to interface with a trip wire 113 as depicted in FIG. 8. The trip wire 113 is connected to an emergency stop switch (known and not depicted) configured to stop further hoisting of the workpiece 904 in response to the arm assembly 106 making contact with the fixture assembly 902, for the case where the fixture assembly 902 remains inadvertently affixed to the workpiece 904 while the workpiece 904 is moved. According to an example, the trip-wire interface assembly 112 may include an extension assembly 118, an angled assembly 124, and a coupling assembly 125. The extension assembly 118 is configured to extend (downwardly) from the arm assembly 106, and is fixedly connected to the arm assembly 106. The extension assembly 118 may include a flat, planar-shaped body. The angled assembly 124 is configured to interface with the trip wire 113; that is, to make contact with the trip wire 113 for the case where the arm assembly 106 has moved from the un-tripped condition to the tripped condition. FIG. 8 depicts the trip-wire interface assembly 112 making contact with the trip wire 113 in the tripped condition. The angled assembly 124 may include a flat metal body that is bent in the medial section of the flat metal body so as to form an angle (such as 90 degrees). The coupling assembly 125 is configured to fixedly couple the extension assembly 118 to the angled assembly 124. The coupling assembly 125 may include any suitable fastener device.

Generally speaking, the detector assembly 104 may be further configured to initiate issuance of a stop signal to a safety circuit configured to halt operation of a machine that is moving (hoisting) the workpiece 904 away from the fixture assembly 902.

FIG. 3 depicts another perspective view of the example of the detector assembly 104 in which the detector assembly 104 is placed in the inboard position and in the tripped condition. The arm assembly 106 is pivoted vertically upwardly in response to the fixture assembly 902, not depicted in FIG. 3 but depicted in FIG. 8, making contact with the arm assembly 106 or with the wear assembly 114 of the arm assembly 106.

FIG. 4 depicts the top view of the example of the detector assembly 104 in which the detector assembly 104 is placed in the inboard position and in the un-tripped condition.

FIG. 5 depicts the side view of the example of the detector assembly 104 in which the detector assembly 104 is placed in the inboard position and in the un-tripped condition.

FIG. 6 depicts the side view of the example of the detector assembly 104 in which the detector assembly 104 is placed in the inboard position and in the tripped condition.

FIG. 7 depicts the frontal view of the example of the detector assembly 104 in which the detector is placed in the inboard position and in the un-tripped condition.

FIG. 8 depicts the perspective view of the example of the detector assembly 104 interacting with the fixture assembly 902. The detector assembly 104 is depicted in the inboard position and in the tripped condition. FIG. 8 depicts the trip-wire interface assembly 112 making contact with the trip wire 113 in the tripped condition. The movable assembly 908 moves (in use) horizontally, from time to time; in order to avoid making interfering contact with movement of the movable assembly 908, the detector assembly 104 is configured to swing out or move away for the case where the movable assembly 908 moves horizontally and makes contact with the arm assembly 106, so that the movable assembly 908 may move as required.

FIG. 9 depicts another perspective view of the example of the detector assembly 104 in which the detector assembly 104 is placed or positioned in the outboard position. In this position, it does not matter whether the detector assembly 104 is placed in the un-tripped condition or the tripped condition because the detector assembly 104 is disabled. For the case where the detector assembly 104 is in a broken (non-operable) state, the detector assembly 104 may be placed in the outboard position and awaits repair by a qualified repair technician. The frame assembly 102 is attached to a relatively stationary structure 906.

Other possible variations, examples or embodiments for the detector assembly 104 include an electronic photo-eye device and/or a proximity switch. These devices (these variations) are interfaced with a PLC (programmable logic controller) having software instructions configured to operate these devices in accordance with the general operational requirements of the detector assembly 104. The electronic photo-eye device is a photodetector used for detecting obstruction of a light beam. The electronic photo-eye device detects presence (and absence) of light. Visible light may be used. The electronic photo-eye device is configured to detect position of the fixture assembly 902 in response to the occurrence in which the fixture assembly 902 remains inadvertently non-separated from the workpiece 904 while the workpiece 904 is moved. The proximity switch (also called a proximity sensor) is a sensor configured to detect the presence of nearby objects without any physical contact. The proximity sensor may emit an electromagnetic field or a beam of electromagnetic radiation (infrared, for instance), and looks for changes in the field or return signal. The object being sensed is often referred to as the proximity sensor's target. The proximity switch is configured to detect proximity of the fixture assembly 902 in response to the occurrence in which the fixture assembly 902 remains inadvertently non-separated from the workpiece 904 while the workpiece 904 is moved.

In view of the foregoing description, it will be appreciated that a method is provided for use with the fixture assembly 902 and the workpiece 904. The method includes detecting the occurrence in which the fixture assembly 902 remains inadvertently non-separated from the workpiece 904 while the workpiece 904 is moved. The method may further include initiating issuance of a stop signal to a safety circuit configured to halt operation of a machine that is moving the workpiece 904.

### ADDITIONAL DESCRIPTION

The apparatus 100 provides the detector assembly 104 configured to detect the case where the pallet assembly 903 or the fixture assembly 902 is stuck to the bottom of the engine assembly 905 or workpiece 904 when the engine assembly 905 is moved via a hoist machine (known and depicted). The apparatus 100 may be configured to initiate shut down of equipment by activating a safety circuit that shuts down the hoist machine. Thus, when the engine assembly 905 is moved to a first elevated position (i.e., the detectable position), the detector assembly 104 detects whether the pallet assembly 903 remains inadvertently attached to the engine assembly 905, which then may activate the safety circuit. The detector assembly 104 may be designed with certain clearance dimensions, due to the fact that the rack, having the engine assembly 905, enters the load cell on a chain conveyor before loading onto a roller conveyor. For example, there may be three engines per rack, with each instance of the engine assembly 905 having its own instance of the pallet assembly 903 from which the engine assembly 905 is removed individually. The detector assembly 104 may be configured to permit movement of the rack (moving in and out) relative to the load station for the case where the detector assembly 104 extends inside of the frame of the rack to detect an inadvertently raised instance of the pallet assembly 903 still connected to the engine assembly 905. The detector assembly 104 is configured to detect the case where the pallet assembly 903 is stuck to the bottom of the engine assembly 905 for the case where the pallet assembly 903 is moved, and may be further configured to optionally activate the safety circuit that shuts down further movement of the engine assembly 905. When the engine assembly 905 is moved to a detection (or scan) position, and if the pallet assembly 903 remains inadvertently attached to the engine assembly 905, the detector assembly 104 may detect this inadvertent condition, and then the safety circuit may be activated if so desired.

It may be appreciated that the assemblies and modules described above may be connected with each other as may be required to perform desired functions and tasks that are within the scope of persons of skill in the art to make such combinations and permutations without having to describe each and every one of them in explicit terms. There is no particular assembly, components that is superior to any of the equivalents available to the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, “includes” is equivalent to the word “comprising.” It is noted that the foregoing has outlined the non-limiting embodiments (examples). The description is made for particular non-limiting embodiments (examples). It is understood that the non-limiting embodiments are merely illustrative as examples.

What is claimed is:

1. An apparatus for use with a fixture assembly and a workpiece, the apparatus comprising:
a frame assembly; and
a detector assembly being configured to:
couple to the frame assembly; and
detect an occurrence in which the fixture assembly remains inadvertently non-separated from the workpiece while the workpiece is moved.

2. The apparatus of claim 1, wherein:
the detector assembly is configured to selectively operate in any one of:
an inboard position in which the detector assembly is enabled to detect the occurrence in which the fixture assembly remains inadvertently non-separated from the workpiece while the workpiece is moved; and
an outboard position in which the detector assembly is disabled from detecting any occurrence in which the fixture assembly remains inadvertently non-separated from the workpiece while the workpiece is moved.

3. The apparatus of claim 1, wherein:
the detector assembly is configured to selectively operate in any one of:
an un-tripped condition in which the detector assembly is ready to detect the occurrence in which the fixture assembly remains inadvertently non-separated from the workpiece while the workpiece is moved; and
a tripped condition in which the detector assembly has detected the occurrence in which the fixture assembly remains inadvertently non-separated from the workpiece while the workpiece is moved.

4. The apparatus of claim 1, wherein:
the detector assembly is further configured to initiate issuance of a stop signal to a safety circuit being configured to halt operation of a machine that is moving the workpiece.

5. The apparatus of claim 1, wherein:
the fixture assembly includes a pallet; and
the workpiece includes an engine being cradled by the pallet.

6. The apparatus of claim 1, wherein:
the detector assembly includes:
an electronic photo-eye device with a programmable logic controller being configured to detect position of the fixture assembly in response to the occurrence in which the occurrence in which the fixture assembly remains inadvertently non-separated from the workpiece while the workpiece is moved.

7. The apparatus of claim 1, wherein:
the detector assembly includes:
a proximity switch with a programmable logic controller being configured to detect proximity of the fixture assembly in response to the occurrence in which the fixture assembly remains inadvertently non-separated from the workpiece while the workpiece is moved.

8. The apparatus of claim 1, wherein:
the detector assembly includes:
an arm assembly being configured to make selective physical contact with the fixture assembly in response to the occurrence in which the fixture assembly remains inadvertently non-separated from the workpiece while the workpiece is moved.

9. The apparatus of claim 1, wherein:
the detector assembly includes:
an arm assembly being configured to make selective physical contact with the fixture assembly in response to the occurrence in which the fixture assembly remains inadvertently non-separated from the workpiece while the workpiece is moved; and
a pivotal assembly being configured to:
operatively couple to the arm assembly; and
permit selective pivotal movement of the arm assembly along any one of a vertically extending direction and a horizontally extending direction.

10. The apparatus of claim 1, wherein:
the detector assembly includes:
an arm assembly being configured to make selective physical contact with the fixture assembly in response to the occurrence in which the fixture assembly remains inadvertently non-separated from the workpiece while the workpiece is moved; and
a pivotal assembly being configured to:
operatively couple to the arm assembly; and
permit selective pivotal movement of the arm assembly between:
an un-tripped condition in which the arm assembly is ready to detect the occurrence in which the fixture assembly remains inadvertently non-separated from the workpiece while the workpiece is moved; and
a tripped condition in which the arm assembly has detected the occurrence in which the fixture assembly remains inadvertently non-separated from the workpiece while the workpiece is moved.

11. The apparatus of claim 1, wherein:
an arm assembly being configured to make selective physical contact with the fixture assembly in response to the occurrence in which the fixture assembly remains inadvertently non-separated from the workpiece while the workpiece is moved; and
a pivotal assembly being configured to:
operatively couple to the arm assembly; and
permit selective pivotal movement of the arm assembly between:
an inboard position in which the detector assembly is enabled to detect the occurrence in which the fixture assembly remains inadvertently non-separated from the workpiece while the workpiece is moved; and
an outboard position in which the detector assembly is disabled from detecting any occurrence in which the fixture assembly remains inadvertently non-separated from the workpiece while the workpiece is moved.

12. The apparatus of claim 1, wherein:
the detector assembly includes:
an arm assembly being configured to make selective physical contact with the fixture assembly in response to the occurrence in which the fixture assembly remains inadvertently non-separated from the workpiece while the workpiece is moved; and
a pivotal assembly being configured to permit selective pivotal movement of the arm assembly along any one of a vertically extending direction and a horizontally extending direction; and
a pivot interface being configured to operatively connect the arm assembly to the pivotal assembly.

13. The apparatus of claim 12, wherein:
the pivot interface includes:
a platform assembly being configured to support the arm assembly.
a pivot fastener being configured to operatively couple the platform assembly to the pivotal assembly;
an extension assembly being configured to connect with the platform assembly, and to extend from the platform assembly; and
a pivotal coupling being configured to pivotally connect the arm assembly to the extension assembly.

14. The apparatus of claim 12, wherein:
the frame assembly includes:
a support assembly being configured to support the pivotal assembly;
a base extension being configured to extend from the support assembly;
a base assembly being configured to connect with the base extension; and
a coupler being configured to attach the support assembly to a relatively stationary structure.

15. The apparatus of claim 12, wherein:
the arm assembly includes:
a wear assembly; and
a connector assembly being configured to connect the wear assembly to a tip of the arm assembly, the wear assembly being configured to make selective contact with the fixture assembly.

16. The apparatus of claim 12, wherein:
the detector assembly further includes:
a trip-wire interface assembly being configured to interface with a trip wire, the trip wire being connected to an emergency stop switch being configured to stop further hoisting of the workpiece in response to the arm assembly making contact with the fixture assembly for a case where the fixture assembly remains inadvertently affixed to the workpiece while the workpiece is moved.

17. The apparatus of claim 16, wherein:
the trip-wire interface assembly includes:
extension assembly being configured to extend from the arm assembly;
an angled assembly being configured to interface with the trip wire; and
a coupling assembly being configured to couple the the extension assembly to the angled assembly.

18. The apparatus of claim 1, wherein:
the detector assembly includes:
an arm assembly being configured to make selective physical contact with the fixture assembly in response to the occurrence in which the fixture assembly remains inadvertently non-separated from the workpiece while the workpiece is moved; and
a pivotal assembly being configured to permit selective pivotal movement of the arm assembly along any one of a vertically extending direction and a horizontally extending direction; and
a pivot interface being configured to operatively connect the arm assembly to the pivotal assembly;
the pivot interface includes:
a platform assembly;
a pivot fastener being configured to operatively couple the platform assembly to the pivotal assembly;
an extension assembly being configured to connect with the platform assembly, and to extend from the platform assembly; and
a pivotal coupling being configured to pivotally connect the arm assembly to the extension assembly;
the arm assembly includes:
a wear assembly; and
a connector assembly being configured to connect the wear assembly to a tip of the arm assembly, the wear assembly being configured to make selective contact with the fixture assembly; and
a trip-wire interface assembly being configured to interface with a trip wire, the trip wire being connected to an emergency stop switch being configured to stop further hoisting of the workpiece in response to the arm assembly making contact with the fixture assembly for a case where the fixture assembly remains inadvertently affixed to the workpiece while the workpiece is moved.

19. A method for use with a fixture assembly and a workpiece, the method comprising:
detecting an occurrence in which the fixture assembly remains inadvertently non-separated from the workpiece while the workpiece is moved.

20. The method of claim 19, further comprising:
initiating issuance of a stop signal to a safety circuit being configured to halt operation of a machine that is moving the workpiece.
